(19) United States
(12) Patent Application Publication
(10) Pub. No.: US 2003/0078064 A1
(43) Pub. Date: Apr. 24, 2003

(54) System and method for queuing talk requests in wireless dispatch system

(76) Inventor: Victor H. Chan, Encinitas, CA (US)

Correspondence Address: Qualcomm Incorporated, Patents Department, 5775 Morehouse Drive, San Diego, CA, 92121-1714, US

(21) Appl. No.: 10/011,861

(22) Filed: Oct. 22, 2001

(51) Int. Cl. H04B 7/00

(52) U.S. Cl. 455/514; 455/517; 455/518

(57) ABSTRACT

A push to talk wireless dispatch service includes a media control unit that establishes, while one remote unit has the floor and push to talk (PTT) signals are received from other remote units, a queue of remote units based the respective times of receipt of the PTT signals and/or priorities of transmission. The transmission channel of the dispatch service, when released by a speaking unit, is granted to the next remote unit in the queue, and so on.

### I. FIELD OF THE INVENTION

The present invention relates generally to wireless dispatch systems wherein groups of users may speak to each other.

### II. BACKGROUND OF THE INVENTION

In a wireless telephone communication system, dispatch services can be provided wherein many users can communicate over a wireless channel to connect to other wireless and wireline telephone systems in a private communication group. Communication over the wireless channel can be one of a variety of multiple access techniques. These multiple access techniques include time division multiple access (TDMA), frequency division multiple access (FDMA), and code division multiple access (CDMA). The CDMA technique has many advantages. An exemplary CDMA system is described in U.S. Pat. No. 4,901,307 issued Feb. 13, 1990 to K. Gilhousen et al., entitled “SPREAD SPECTRUM MULTIPLE ACCESS COMMUNICATION SYSTEM USING SATELLITE OR TERRESTRIAL REPEATERS,” assigned to the assignee of the present invention and incorporated herein by reference.

While typical wireless and wireline telephone service provides point-to-point service, dispatching services provide one-to-many service. Common applications of dispatch services include local police radio systems, taxicab dispatch systems, Federal Bureau of Investigation and secret service operations, and general military communication systems.

The basic model of a wireless dispatch system consists of a broadcast net or group of users. Each user monitors a common broadcast forward link signal. If a user wishes to talk, the user requests permission to use a reverse link transmission channel by, e.g., pressing a push-to-talk (PTT) button. The talking user's voice is routed from the reverse link to telephony infrastructure and broadcast to other group members over the forward link. Ideally, the dispatch system allows landline and wireless access to the system.

When a user of a remote unit which is part of a wireless dispatch system presses the push-to-talk button, the user would like to immediately begin speaking. In a group of many users, this may not always be possible if more than user at once wants to talk. What usually happens is that a person wishing to speak waits until he or she senses a pause in the conversation, at which time the user presses the PTT button and begins speaking, hoping that the net is clear and that other users won't simultaneously jump in and talk. To avoid interference between users, conventional systems “prioritize” transmissions by locking out other users from talking once one user has pushed his or her PTT button. When the speaking user releases the PTT button, the lock-out is released, so that the first user to subsequently press his or her PTT button is given the floor.

The present invention recognizes, however, that with relatively large groups of users, particularly when engaged in a heated discussion, the above-mentioned “prioritization” can be inadequate. For example, less aggressive members of the group can be shut out of the discussion by more aggressive members who constantly depress and release their PTT buttons. Moreover, no distinction is made between a later user who has just pressed her PTT button at the termination of a lock-out and an earlier user who might have previously pushed his PTT button prior to lock-out release in a vain effort to be heard. Having recognized the above-noted problems, the present invention provides the below-noted solutions to one or more of them.

### SUMMARY OF THE INVENTION

A method for providing a dispatch service to plural users of remote units in a dispatch network includes receiving a first push to talk (PTT) request from a first remote unit. In response to the first PTT request, the first remote unit is granted a transmitting communication channel. The method then contemplates receiving at least a second PTT request from a second remote unit while the first remote unit is granted the transmitting communication channel. A first place in a waiting queue is designated in response to the second PTT request.

In a preferred embodiment, the place in the queue is associated with the second PTT request, or, equivalently, with the identification of the second remote unit that generated the request.

In any case, in a more specific implementation the method includes receiving at least a third PPT request from a third remote unit while the first remote unit is granted the transmitting communication channel, with the third request being later in time, or being of lower priority, than the second request. A second place in the waiting queue is designated in response to the third PTT request. In accordance with this preferred embodiment, the second place in the queue is behind the first place in the queue such that the second remote unit is granted priority over the third remote unit to transmit upon release of the transmission channel from the first remote unit.

In further preferred implementations, the method includes preventing other remote units from transmitting in the dispatch network while the transmission channel remains granted to the first remote unit. If desired, a message can be sent to the second remote unit that represents a place in the queue that is associated with the second remote unit. This place in the queue can be presented on a display that is associated with the second remote unit. Additionally, a message can be sent to the second remote unit representing permission for the second remote unit to use the transmission channel when the channel is released. In a specific, non-limiting implementation, the messages can be in an IP-based protocol, and the dispatch service can use CDMA.

In another aspect, a dispatch service system includes plural remote units communicating with each other using a dispatch service using wireless communication principles. A media control unit (MCU) establishes a queue based on push to talk (PTT) signals from remote units and respective times and/or priorities associated with the PTT signals, with the queue being useful for granting remote units associated with the queue a transmission channel of the dispatch service based on respective positions in the queue.

In still another aspect, a wireless dispatch system serving plural remote units includes at least one processor that in turn includes means for receiving, from waiting remote units, requests to transmit information using a transmission channel in the system while a transmitting remote unit is granted permission to use the transmission channel. The processor also includes means for queuing the waiting remote units based at least in part on respective times and/or priorities associated with the requests to transmit. Means are provided for granting transmission channel access to the waiting remote units based on the means for queuing.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present system; and

FIG. 2 is a flow chart of the present logic.

### DETAILED DESCRIPTION OF THE PREFERRED EMBODIMENT

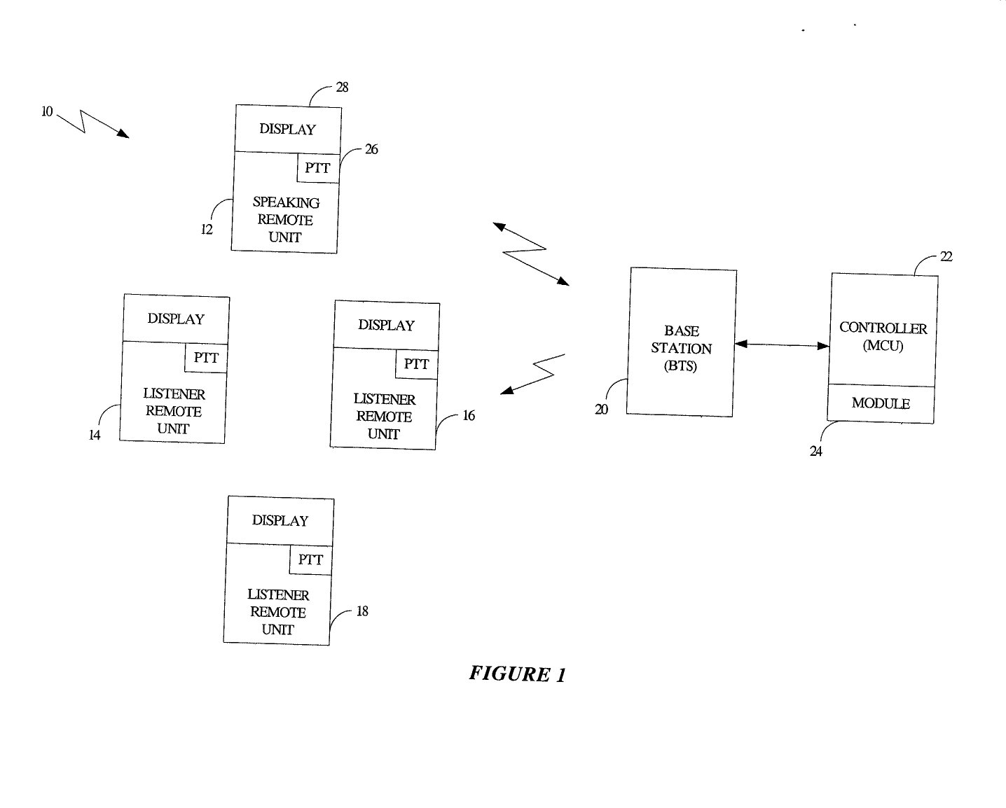

Referring initially to FIG. 1, a dispatch system is shown, generally designated 10. In the preferred embodiment, remote units 12, 14, 16, and 18 such as but not limited to wireless telephones may function both as dispatch units and as point-to-point telephones. For illustration, assume that the remote unit 12 has been granted use of the transmission channel of the system and thus is an active talker, and further assume that remote units 14, 16, and 18 are non-talking listeners.

FIG. 1 shows that a base station 20 can provide the broadcast forward link channel to the listening remote units 14, 16, and 18. Moreover, the base station 20 can connect a dedicated forward and reverse traffic channel to the talking remote unit 12. The dedicated traffic channel is similar to the forward link broadcast channel except that, for example, the talking remote unit 12 may receive other remote unit specific signalling information such as power control commands. The dedicated traffic channel also carries power control and signaling information. The base station 20 also receives a reverse link signal from the talking remote unit 12.

FIG. 1 further shows that the base station 20 communicates with a media control unit (MCU) 22 having access to a logic module 24 that embodies the logic discussed below. The MCU 22 can be implemented in the base station 20, or in a base station controller, or in a mobile switching center (MSC), or indeed in another wireless telephony infrastructure.

In one exemplary, non-limiting embodiment, the remote units 12, 14, 16, 18 are mobile telephones made by Kyocera, Samsung, or other manufacturer that use Code Division Multiple Access (CDMA) principles and CDMA over-the-air (OTA) communication air interface protocols such as defined in but not limited to IS-95A, IS-95B, WCDMA, IS-2000, and others. For instance, the wireless communication systems to which the present invention can apply, in amplification to those noted above, include Personal Communications Service (PCS) and cellular systems, such as Analog Advanced Mobile Phone System (AMPS) and the following digital systems: CDMA, Time Division Multiple Access (TDMA), and hybrid systems that use both TDMA and CDMA technologies. A CDMA cellular system is described in the Telecommunications Industry Association/Electronic Industries Association (TIA/EIA) Standard IS-95. Combined AMPS and CDMA systems are described in TIA/EIA Standard IS-98. Other communications systems are described in the International Mobile Telecommunications System 2000/Universal Mobile Telecommunications Systems (EqT-2000/UM), standards covering what are referred to as wideband CDMA (WCDMA), cdma2000 (such as cdma2000 1x or 3x standards, for example) or TD-SCDMA.

The present invention applies to any remote units 12, 14, 16, 18. In general, wireless communication devices to which the present invention applies may include but are not limited to a wireless handset or telephone, a cellular phone, a data transceiver, or a paging and position determination receiver, and can be hand-held, or portable as in vehicle-mounted (including cars, trucks, boats, planes, trains), as desired. However, while wireless communication devices are generally viewed as being mobile, it is to be understood that the present invention can be applied to “fixed” units in some implementations, such as a computer terminal or a personal computer via IP/VOIP. Also, the present invention applies to data modules or modems used to transfer voice and/or data information including digitized video information, and may communicate with other devices using wired or wireless links. Further, commands might be used to cause modems or modules to work in a predetermined coordinated or associated manner to transfer information over multiple communication channels. Wireless communication devices are also sometimes referred to as user terminals, mobile stations, mobile units, subscriber units, mobile radios or radiotelephones, wireless units, or simply as “users” and “mobiles” in some communication systems.

In FIG. 1, the talking remote unit 12 has an established bidirectional link with the base station 20. To become active, a remote unit sends a transmission request by, e.g., sending an access channel message requesting a traffic channel to the base station 20. In one non-limiting embodiment, this access channel message can be generated in response to a user appropriately manipulating a push-to-talk (PTT) button 26 on the remote unit 20. Also, each remote unit 12, 14, 16, 18 can include a visual display 28 as shown, for purposes to be shortly disclosed.

When the remote unit 12 has established a communication link, it receives the signaling of the forward broadcast channel on a dedicated forward link traffic channel. In this way, the remote unit 12 does not monitor the forward link broadcast channel, and it receives all of the dispatch system information on its own dedicated forward link traffic channel. Also, as mentioned above the remote unit 12 communicates back to the base station 20 on a dedicated reverse channel. Because the talking remote unit 12 has its own dedicated forward link signal path, remote unit specific messaging can be included in the signaling if desired. For example, if the talking remote unit 12 is capable of operating both as a dispatch system remote unit and as a point-to-point telephone unit, the remote unit 12 can be informed on the forward link traffic channel that an incoming point-to-point call is being directed toward the remote unit 12.

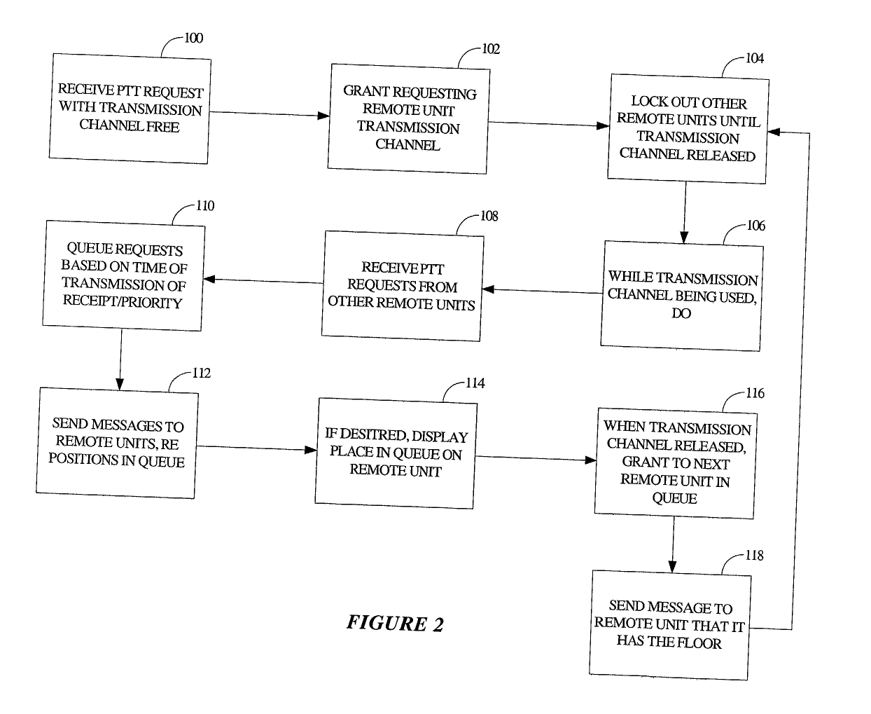

With the above architectural overview in mind, attention is now directed to FIG. 2. It is to be understood that the present logic is executed on the architecture shown in FIG. 1 in accordance with the flow charts discussed below. The flow charts herein illustrate the structure of the logic of the present invention as embodied in computer program software. Those skilled in the art will appreciate that the flow charts illustrate the structures of logic elements, such as computer program code elements or electronic logic circuits, that function according to this invention.

Manifestly, the invention is practiced in its essential embodiment by a machine component that renders the logic elements in a form that instructs a digital processing apparatus (that is, a computer, controller, processor, etc.) to perform a sequence of function steps corresponding to those shown.

In other words, the logic may be embodied by a computer program that is executed by processors within the above-described components as a series of computer- or control element-executable instructions. These instructions may reside, for example, in RAM or on a hard drive or optical drive, or the instructions may be stored on magnetic tape, electronic read-only memory, or other appropriate data storage device that can be dynamically changed or updated.

Now referring to the logic flow chart of FIG. 2, commencing at block 100 a request to transmit voice or data information in a dispatch network (i.e., a private network used only by members of a group) is received. In one exemplary, non-limiting embodiment, the request is made using push to talk (PTT) principles, wherein a PTT button 26 on a remote unit, e.g., the talking remote unit 12, is appropriately manipulated. However, the principles advanced herein apply equally to other modes of transmission requests.

Moving to block 102, assuming that no other remote unit has transmission permission, the requesting remote unit is granted the transmission channel of the dispatch network. Proceeding to block 104, other remote units in the dispatch group, e.g., the listening remote units 14, 16, 18, are locked out from transmitting in accordance with dispatch network principles known in the art. However, for those listening remote units 14, 16, 18 that generate PTT requests during the lock-out, the logic enters a DO loop at block 106 and proceeds to block 108 to receive these requests from locked-out remote units.

After receiving one or more PTT requests from locked-out units 14, 16, 18, the logic moves to block 110 where the requests are queued based on the time they were received, or equivalently, based on the time they were transmitted, should network latency be a consideration. In addition to or in lieu of time, if desired the requests can be queued based on priority indicia, such as relative importance of a remote unit or relative importance, as indicated in the request, of the transmission for which permission is being sought. It is to be understood that the present invention encompasses the above-disclosed queuing regardless of whether positions in the queue are designated by remote unit identification or PTT request or time of request or indeed by integer sequence. The queue can be implemented by any suitable data structure, such as but not limited to lists, tables, etc.

In addition to queuing transmission requests at block 110, the preferred non-limiting logic also informs requesting remote units that their respective requests have been queued at block 112. This can be accomplished by sending, for instance, an IP protocol-based message such as a SIP message to the remote units, indicating their respective places in the queue, e.g., “next to talk”, “two users ahead of you”, and so on. Or, the message needs to contain simply an integer representing the order in the queue occupied by the particular remote unit. If desired, the individual remote units can display, at block 114, their places in the queue as indicated in the messages sent at block 112. This display can be an integer representing the remote unit's place in the queue and presented on the display of the remote unit, or it can be an explanatory alpha-numeric message.

When the transmission channel is released at block 116 by the remote unit to which it has been granted, the first remote unit in the queue is granted the transmission channel. This can be accompanied by sending the remote unit a message to this effect at block 118, with the remote unit emitting an audible and/or visible indication or alarm or otherwise indicating to the user that the user may talk. The message can be a SIP message or other IP protocol-formatted message. The logic then loops back to block 106 to lock out other remote units, remove the now-talking remote unit from the queue, and proceed in accordance with the above disclosure.

While the particular SYSTEM AND METHOD FOR QUEUING PUSH TO TALK REQUESTS IN WIRELESS DISPATCH SYSTEM as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”.

What is claimed is:

1. A method for providing a dispatch service to plural users of remote units in a dispatch network, comprising:
receiving a first push to talk (PTT) request from a first remote unit and in response to the first PTT request granting the first remote unit at least one transmitting communication channel;
receiving at least a second PTT request from a second remote unit while the first remote unit is granted the transmitting communication channel; and
designating a first place in a waiting queue in response to the second PTT request.

2. The method of claim 1, wherein the place in the queue is associated with the second PTT request.

3. The method of claim 1, wherein the place in the queue is associated with the second remote unit.

4. The method of claim 1, further comprising:
receiving at least a third PTT request from a third remote unit while the first remote unit is granted the transmitting communication channel, the third request being later in time or being of lower priority than the second request; and
designating a second place in the waiting queue in response to the third PTT request, the second place in the queue being behind the first place in the queue whereby the second remote unit is granted priority over the third remote unit to transmit upon release of the transmission channel from the first remote unit.

5. The method of claim 1, further comprising preventing other remote units from transmitting in the dispatch network while the transmission channel remains granted to the first remote unit.

6. The method of claim 1, further comprising sending at least one message to the second remote unit representing a place in the queue associated with the second remote unit.

7. The method of claim 6, further comprising displaying the place in the queue on a display associated with the second remote unit.

8. The method of claim 6, further comprising sending a message to the second remote unit representing permission for the second remote unit to use the transmission channel, based on the place in the queue associated with the second remote unit.

9. The method of claim 8, wherein the message is in an IP-based protocol.

10. The method of claim 1, wherein the dispatch service uses CDMA.

11. A dispatch service system, comprising:
plural remote units communicating with each other using a dispatch service using wireless communication principles; and
at least one media control unit (MCU) establishing a queue based on push to talk (PTT) signals from remote units and at least one of: respective times, and respective priorities, associated with the PTT signals, the queue being useful for granting remote units associated with the queue a transmission channel of the dispatch service based on respective positions in the queue.

12. The system of claim 11, wherein the MCU sends at least one message to at least a queued remote unit representing a place in the queue associated with the queued remote unit.

13. The system of claim 12, further comprising a display on the queued remote unit representing its place in the queue.

14. The system of claim 12, wherein the MCU sends a message to the queued remote unit representing permission for the queued remote unit to use the transmission channel, based on the place in the queue associated with the queued remote unit.

15. The system of claim 14, wherein the message is in an IP-based protocol.

16. The system of claim 11, wherein the dispatch service uses CDMA.

17. A wireless dispatch system serving plural remote units comprising:
at least one processor including:
means for receiving, from waiting remote units, requests to transmit information using a transmission channel in the system while a transmitting remote unit is granted permission to use the transmission channel;
means for queuing the waiting remote units based at least in part on respective times and/or priorities associated with the requests to transmit; and
means for granting transmission channel access to the waiting remote units based on the means for queuing.

18. The system of claim 17, comprising means for sending at least one message to at least one waiting remote unit representing a place in the queue associated with the waiting remote unit.

19. The system of claim 17, further comprising a display on at least one waiting remote unit representing its place in the queue.

20. The system of claim 17, further comprising means for sending a message to at least one waiting remote unit representing permission for the waiting remote unit to use the transmission channel, based on the place in the queue associated with the waiting remote unit.

21. The system of claim 20, wherein the message is in an IP-based protocol.

22. The system of claim 17, wherein the dispatch service uses CDMA.
